(19) United States
(12) Patent Application Publication
(10) Pub. No.: US 2023/0068418 A1
(43) Pub. Date: Mar. 2, 2023

(54) MACHINE LEARNING MODEL CLASSIFYING DATA SET DISTRIBUTION TYPE FROM MINIMUM NUMBER OF SAMPLES

(71) Applicant: Hewlett-Packard Development Company, L.P., Spring, TX (US)

(72) Inventors: Sagar Sharma, Vancouver, WA (US); Mike Holmberg, Boise, ID (US)

(21) Appl. No.: 17/462,424

(22) Filed: Aug. 31, 2021

(51) Int. Cl. G06N 3/08

(52) U.S. Cl. CPC G06N 3/08

(57) ABSTRACT

A machine learning model classifies a distribution type of an input data set from a minimum number of initial samples of the input data set. A data anonymization protocol can be adjusted based on the classified distribution type. Additional samples of the input data set can be centrally collected in accordance with the data anonymization protocol as adjusted.

### BACKGROUND

Data is regularly centrally collected from a wide variety of different client devices for analytical and other purposes. For example, on the basis of such centrally collected data analysis, how the client devices and their running applications can be improved can be assessed, and impending or actual failures or malfunctions detected such that appropriate reactive and proactive actions can be performed. Client devices in this respect can include individual user devices, such as desktop, laptop, and notebook computers, as well as smartphones, tablet computing devices, and other types of computing devices. Client devices can also include peripheral devices such as printing and other imaging devices, as well as Internet-of-Things (loT) devices that may be computationally lightweight and low-cost devices that primarily report data.

### BRIEF DESCRIPTION OF THE DRAWINGS

FIG. 1 is a diagram of an example system in which a server device centrally collects data from client devices.

FIG. 2 is a diagram of an example architecture in which a data anonymization protocol governing central collection of data is adjusted based on an estimated distribution of the data.

FIG. 3 is a diagram of an example process in which data is subjected to a data anonymization protocol that uses variably sized data collection bins, such as an adaptive differential privacy protocol, during central collection.

FIG. 4 is a flowchart of an example method for adjusting central collection of data in which distribution type is centrally predicted at a server device on the basis of a limited amount of non-anonymized data transmitted to the server device from client devices.

FIGS. 5A and 5B are flowcharts of an example method for adjusting central collection of data in which distribution type is locally predicted at client devices, such that no non-anonymized data has to be transmitted to a server device for such prediction.

FIG. 5C is a flowchart of another example method for adjusting central collection of data in which distribution type is locally predicted at client devices, such that no non-anonymized data has to be transmitted to a server device for such prediction.

FIG. 6 is a flowchart of an example process for training a machine learning model to predict the underlying distribution type of a data set from a minimum number of samples of the data set, on the basis of those samples.

FIG. 7 is a flowchart of an example process for training an image-based machine learning model to predict the underlying distribution type of a data set from a minimum number of samples of the data set, on the basis of an image plotting those samples.

FIG. 8 is a flowchart of an example method.

FIG. 9 is a diagram of an example non-transitory computer-readable data storage medium.

FIG. 10 is a diagram of an example server device.

### DETAILED DESCRIPTION

As noted in the background, data is often centrally collected from client devices for analytical and other purposes. While such central data collection is beneficial, users may be hesitant to share their data in this way due to privacy concerns. Moreover, governmental regulations can dictate how the data can be collected. Therefore, before data is reported from a client device, the data may be subjected to a data anonymization protocol that effectively removes identifying information from the data and prevents such identifying information of the devices and/or their users from being discerned from the reported data. Adjusting centralized collection of data in this matter can mitigate users' privacy concerns and satisfy privacy-related governmental regulations.

One type of data anonymization protocol is an adaptive differential privacy protocol. An example of an adaptive differential privacy protocol is described in the pending PCT patent application “Determination of data parameters based on distribution of data for privacy protection,” filed on Oct. 5, 2020, and assigned patent application number PCT/US2020/053830. In accordance with an adaptive differential privacy protocol, a client device may instead of reporting the raw data that the client device collects report the number of values that fall in each of a number of data collection bins. The server device centrally collecting the reported data from the client devices therefore receives an obfuscated version of the data collected at each client device. Furthermore, the reported data may constitute a probabilistically accurate response, such that the server device cannot ascertain with 100% confidence that any given data sent is correct or random.

In an adaptive differential privacy protocol, the data collection bins are variably sized, instead of uniformly sized, in accordance with the distribution of the data being centrally collected. That is, an adaptive differential privacy protocol adapts individual bin sizes according to the underlying distribution of the data being collected. For example, for data values within the range of 1 and 100, instead of having equally sized bins corresponding to values 1-5, 6-10, 11-15, . . . , 95-100, the bins are variably sized based on the underlying distribution of the data being collected. Data values that are collected at higher frequency are assigned to smaller sized bins (e.g., corresponding to fewer values), and data values that are collected at lower frequency are assigned to larger sized bins (e.g., corresponding to more values).

An adaptive differential privacy protocol improves the quality of the data being centrally collected, while still preserving privacy. Because the data is reported over data collection bins that reflect the underlying distribution of the data being collected, analyses performed on the data can result in better and more accurate conclusions being drawn. However, the distribution of the data being collected has to be approximately known before an adaptive differential privacy protocol can be applied to the data. This can lead to a chicken-and-egg problem, in which the distribution of the data may not be known until after the data has been collected, but collecting the data in a privacy-preserving manner according to an adaptive differential privacy protocol necessitates that the distribution be approximately known, or otherwise the quality of the centrally collected data will suffer.

Techniques described herein classify the distribution type of a data set from a minimum number of samples of the data set, using a machine learning model. For example, the distribution type may be predicted from a small number of initial data samples. Subsequent collection of additional data samples can then be adjusted according to the predicted distribution type of the data set. A data anonymization protocol, such as an adaptive differential privacy protocol, may be adjusted, for instance, based on the predicted distribution of the data set. Depending on whether the distribution type is predicted locally at individual client devices or centrally at a server device, either no samples or just the small number of initial samples are transmitted to the server device without first being subjected to data anonymization.

The described techniques have been shown to be able to classify data set distribution type using as few as ten initial samples while still maintaining nearly 100% classification accuracy (as a specified accuracy). Even limiting the initial number of samples to as few as five has been shown to still result in greater than 90% accuracy (as a specified accuracy) in classifying the distribution type of the data set. The result is that the central collection of subsequent samples of the data set can be adjusted according to the classified distribution type to improve such collection. As noted, for instance, a data anonymization protocol such as an adaptive differential privacy protocol that governs central data collection can be adjusted in such a way that the quality of the data is improved in terms of the accuracy of subsequent analyses that can be performed on the data. More generally, therefore, the described techniques can classify data set distribution type using no more than ten initial samples while still maintaining a specified accuracy of 90% or higher. For example, such a minimum number of samples is sufficient for a machine learning model to classify distribution type with a specified accuracy.

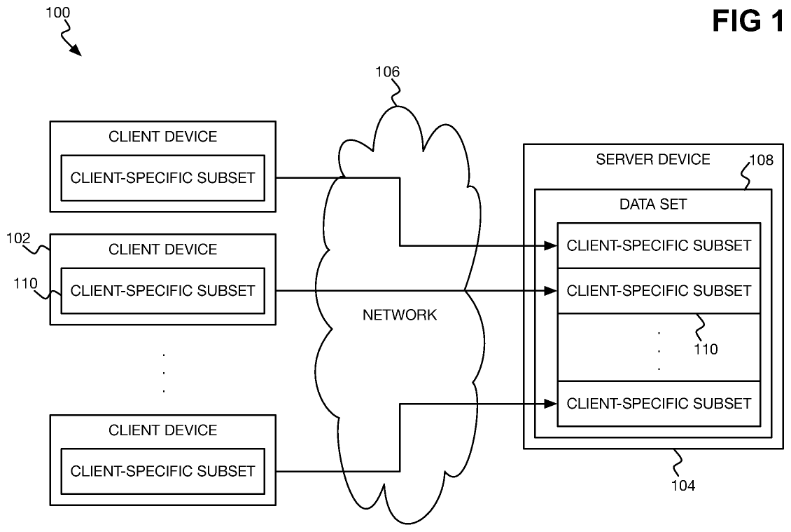

FIG. 1 shows an example system 100 including multiple client devices 102 and a server device 104 that are communicatively connected to one another over a network 106. The client devices 102 can include individual user devices, such as desktop, laptop, and notebook computers, as well as smartphones, tablet computing devices, and other types of computing devices. The client devices 102 can additionally or instead include peripheral devices such as printing and other imaging devices, as well as Internet-of-Things (loT) devices. The server device 104 may be one or multiple such server devices providing a cloud service to and with which the client devices 102 interact. The network 106 may be or include the Internet, an intranet, an extranet, a local-area network (LAN), a wide-area network (WAN), a wired network, a wireless network, a mobile communication network, and so on.

The server device 104 centrally collects a data set 108 from the client devices 102 over the network 106. The data set 108 is made up of client-specific subsets 110 that respectively correspond to the client devices 102. Each client device 102 thus locally collects its client-specific subset 110 of the data set 108 and reports it over the network 106 to the server device 104. By receiving the reported client-specific subset 110 from each client device 102, the server device 104 therefore centrally collects the data set 108 in its entirety from the client devices 102. The client devices 102 may each report its client-specific subset 110 as data samples (i.e., data values) of the subset 110 are generated or locally collected, or may periodically report groups of samples in batch form.

For example, a client device 102 may report the samples of its client-specific subset 110 when a number of samples has been locally collected. Therefore, during times in which more samples are locally collected, the client device 102 reports at higher frequency (i.e., more often) to the server device 104 as compared to during times in which fewer samples are locally collected. As another example, a client device 102 may report the samples of its client-specific subset 110 at the end of every period of time, which may be measurable in seconds, minutes, hours, days and so on, regardless of the number of samples that were locally collected in that period of time. Therefore, during times in which more samples are locally collected, the client device 102 reports more samples to the server device 104 as compared to during times in which fewer samples are locally collected.

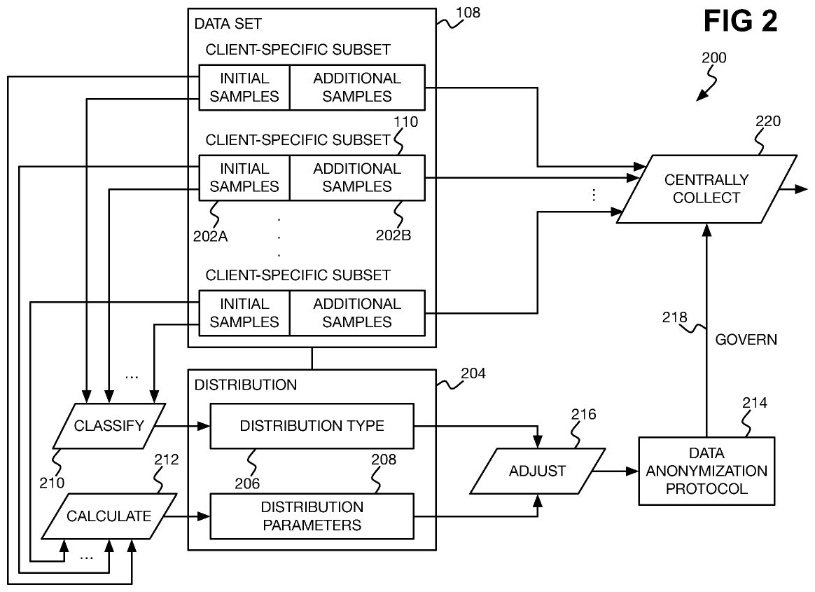

FIG. 2 shows an example architecture 200 by which central collection of the data set 108 can be adjusted. The data set 108 is made up of client-specific subsets 110 respectively corresponding to the client devices 102 of FIG. 1, as noted. Each data set 108 includes a number of initial data samples 202A and a number of additional data samples 202B, which are collectively referred to as the data samples 202. The initial samples 202A of a client-specific subset 110 may be those that are locally collected first by a respective client device 102, or those that are otherwise selected first by the client device 102 in question. The additional samples 202B are those of the client-specific subset 110 other than the initial samples 202A. The client-specific subsets 110 and thus the data set 108 as a whole may not be bounded in size or in number of samples. For example, additional samples 202B of a client-specific subset 110 may be locally collected indefinitely as they are generated at the respective client device 102.

The data set 108 made up of the client-specific subsets 110 of data samples 202 has a distribution 204 that includes and is defined by a distribution type 206 and distribution parameters 208. The distribution 204 may also be referred to as a statistical or probability distribution, and may be considered as a mathematical function specifying the values (i.e., the data samples 202) of the data set 108. The distribution type 206 is the type of the distribution 204 of the data set 108. For example, the distribution type may be normal, exponential, lognormal, uniform, Beta, binomial, negative binomial, Poisson, and so on.

The distribution parameters 208 are the parameters governing the distribution 204, in that the parameters 208 instantiate the distribution 204 as a particular distribution of the distribution type 206. That is, whereas the distribution type 206 generally specifies the distribution 204, the distribution type 206 together with the distribution parameters 208 completely specifies the distribution 204. The distribution parameters 208 are specific to the distribution type 206. For example, a normal distribution may have distribution parameters 208 of mean and standard deviation, whereas an exponential distribution may have a single distribution parameter 208 of rate or scale.

In general, in the architecture 200, the distribution type 206 of the distribution 204 of the data set 108 is classified (210) from the initial samples 202A of the client-specific subsets 110 of the data set 108. The distribution parameters 208 of the distribution 204 of the data set 108 that has the classified distribution type 206 are similarly calculated (212) from the initial samples 202A of the client-specific subsets 110. A data anonymization protocol 214, such as an adaptive differential privacy protocol, is adjusted (216) based on the classified distribution type 206 and the calculated distribution parameters 208 of the distribution 204 of the data set 108. Because the distribution type 206 and the distribution parameters define the distribution 204, the data anonymization protocol 214 can thus be considered as being adjusted based on the distribution 204 of the data set 108.

The data anonymization protocol 214 governs (218) central collection 220 of the additional samples 202B of the client-specific subsets 110 (and in some cases, the initial samples 202A as well) from respective client devices 102 by the sever device 104 of FIG. 1. As noted, the data anonymization protocol 214 may specify that the client devices 102 are to report the samples 202 by reporting the number of samples 202 that have been assigned to each of a number of data collection bins of variable size. The number and sizes of the data collection bins in a given such data anonymization protocol 214 can vary according to the distribution type 206 and the distribution parameters 208 of the data set 108 being centrally collected. Therefore, adaptively adjusting the data collection bins in this way based on the classified distribution type 206 and the calculated distribution parameters 208 effectively adjusts how the data set 108 is centrally collected, since the data anonymization protocol 214 governs such central collection of the data set 108.

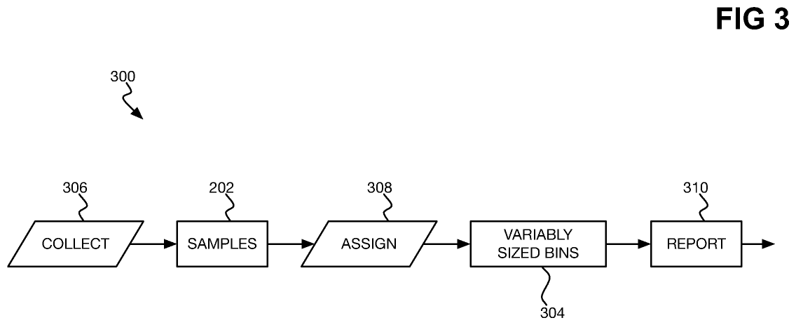

FIG. 3 shows an example process 300 by which data samples 202 are subjected to a data anonymization protocol 214, such as an adaptive differential privacy protocol, that employs variably sized bins in their central collection at the server device 104 of FIG. 1. The process 300 is specifically performed by each client device 102. A client device 102 thus locally collects (306) the data samples 202 that may have been generated by, at, or for the client device 102. As the data samples 202 are collected, after a specified number of samples 202 are collected, or at regular time periods, the client device 102 assigns (308) the locally collected data samples 202 into variably sized data collection bins 304, as has been adapted to the data set 108 as a whole based on the distribution 204 of the data set 108 per FIG. 2.

The client device 102 then reports (310) the data samples 202 to the server device 104 by specifically reporting the number of samples 202 assigned to each data collection bin 304. In the case in which the data samples 202 are reported as they are locally collected, the bin 304 to which a data sample 202 has been assigned is reported. The server device 104 therefore does not receive the actual data samples 202—i.e., their actual values—but rather just the count of the samples 202 in each variably sized bin 304. In one implementation, the server device 104 may just receive probabilistic response of the count of the samples 202 in each variably sized bin 304, such that the server device 104 cannot ascertain with 100% confidence whether any given sample 202 or any given count is accurate. Because each client device 102 of FIG. 1 reports the samples 202 of its respective client-specific subset 110 in the same manner, the server device 104 centrally collects the data set 108 made up of the client-specific subsets 110 in a manner that has been adjusted based on the distribution 204 of the data set 108 per FIG. 2.

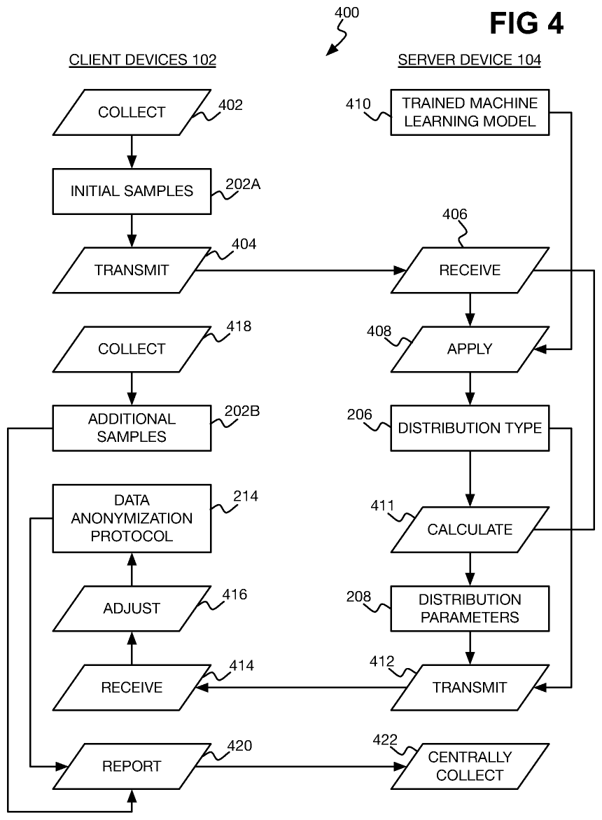

FIG. 4 shows an example method 400 for adjusting central data set collection in which distribution type 206 is centrally predicted at the server device 104, as opposed to being initially predicted at each client device 102. The left part of the method 400 is performed by the client devices 102 and the right part is performed by the server device 104. The method 400 may be implemented as program code stored on a non-transitory computer-readable data storage medium and executed by a processor of a respective device. As one example, program code may be executed by a processor of a client device 102 to perform the left part of the method 400.

Each client device 102 locally collects (402) initial samples 202A of its respective client-specific subset 110 of the data set 108, and transmits (404) the initial samples 202A to the server device 406, which responsively receives (406) the samples 202A. The server device 104 applies (408) a trained machine learning model 410 to the initial samples 202A received from the client devices 102 as a whole to predict the distribution type 206 of the data set 108. The machine learning model 410 is trained to classify distribution type of an input data set from a minimum number of samples of the data set, including as few as five or ten such samples. Example training of such a machine learning model 410 is described in detail later in the detailed description.

In the example of FIG. 4, it is the server device 104, and not the client devices 102, that applies the trained machine learning model 410 to the initial samples 202. This means that the server device 104 has to receive the initial samples 202 before they are subjected to data anonymization. The method 400 is thus appropriate when divulging a limited number of initial samples 202 that potentially may have personally identifying information is acceptable. Furthermore, in the example of FIG. 4, the server device 104 applies the machine learning model 410 once, to the initial samples 202A from all the client devices 102, in order to classify the distribution type 206 of the data set 108, as opposed to applying the machine learning model 410 to the initial samples 202 from each client device 102 individually.

The server device 104 further calculates (411) the distribution parameters 208 for the distribution 204 of the data set 108, from the initial samples 202A received from all the client devices 102. Which distribution parameters 208 that are calculated depend on the distribution type 206 of the distribution 204. Therefore, the distribution parameters 208 are calculated after the distribution type 206 has been classified, or predicted, via usage of the trained machine learning model 410. The server device 104 transmits (412) both the classified distribution type 206 and the calculated distribution parameters 208 that define the distribution of the data set 108 to each client device 102, which responsively receives (414) them.

The client devices 102 in turn each adjust (416) the data anonymization protocol 214 governing central collection of the client-specific subsets 110 of the data set 108 at the server device 104 based on the received distribution type 206 and distribution parameters 208, as has been described. Each client device 102 collects (418) the additional samples 202B of its respective client-specific subset 110 of the data set 108, and reports (420) the samples 202B to the server device 104 in accordance with the adjusted data anonymization protocol 214, as has also been described. The server device 104 therefore centrally collects (422) the additional samples 202B from the client devices 102 as have been anonymized via the data anonymization protocol 214 that was adjusted according to the distribution 204 of the data set 108.

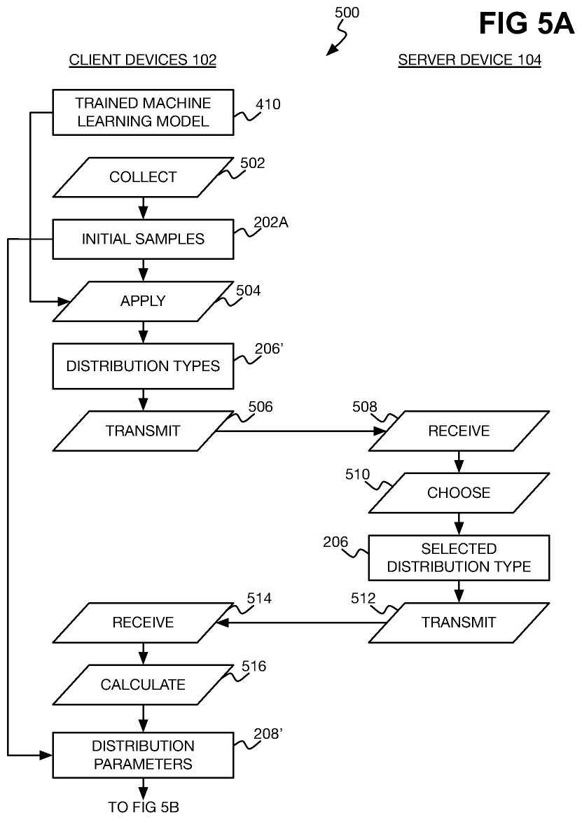

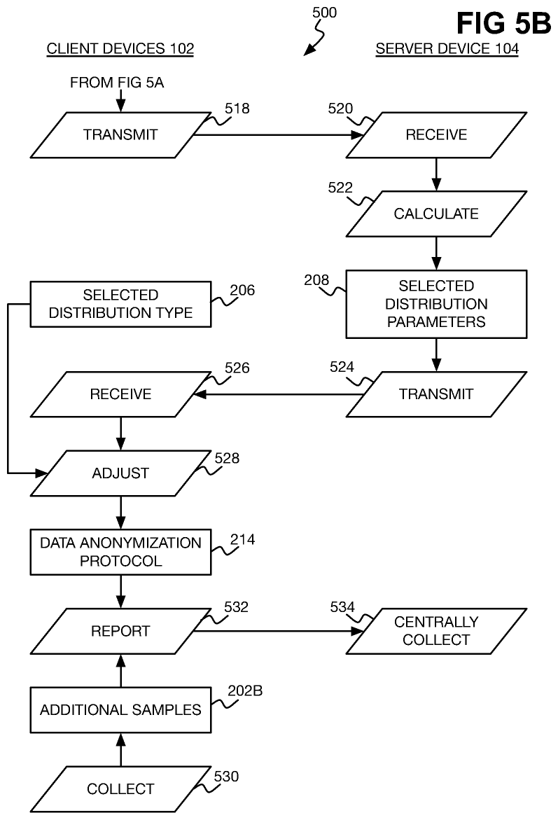

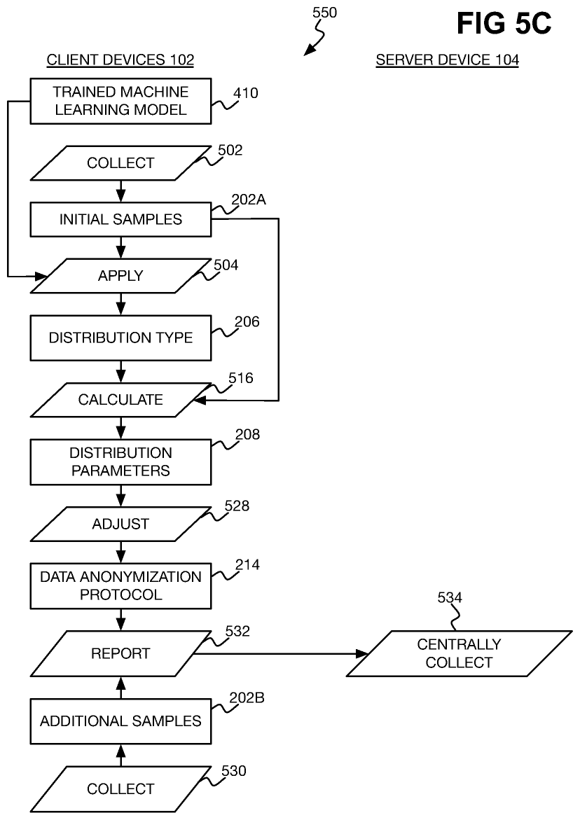

FIGS. 5A and 5B show an example method 500 for adjusting central data set collection in which distribution type 206 is initially predicted at each client device 102, instead of being centrally predicted at the server device 104 as in FIG. 4. The left part of the method 500 is again performed by the client devices 102 and the right part by the server device 104. The method 500, like the method 400, may be implemented as program code stored on a non-transitory computer-readable data storage medium and executed by a processor of a respective device. As one example, program code may be executed by a processor of the server device 104 to perform the right part of the method 500.

Each client device 102 locally collects (502) initial samples 202A of its respective client-specific subset 110 of the data set 108. Unlike in FIG. 4, however, the client devices 102 do not transmit the initial samples 202A to the server device 104. Rather, each client device 102 applies (504) the trained machine learning model 410 to its initial samples 202A to predict or classify the distribution type 206′ of the data set 108. There are thus multiple predicted distribution types 206′, one for each client device 102 as classified based on the initial samples 202A of the client-specific subset 110 corresponding to that client device 102. In this way, the distribution types 206′ differ from the distribution type 206, which is the distribution type 206 of the data set 108 predicted or classified based on the initial samples 202A collected by all the client devices 102, as opposed to a distribution type 206′ of the data set 108 that is predicted or classified based on the initial samples 202A collected by one such client device 102.

The client devices 102 transmit (506) their respective predicted distribution types 206′ to the server device 104, which responsively receives (508) the distribution types 206′. The server device 104 chooses (510) one of the predicted distribution types 206′ to serve as the selected distribution type 206 that will govern the central collection of the data set 108 from all the client devices 102. For instance, the server device 104 may choose the selected distribution type 206 predicted by the highest number of client devices 102. For example, if there are fifty client devices 102, and forty each predict a distribution type 206′ of normal and the remaining ten each predict a distribution type 206′ of exponential, then the server device 104 may select the distribution type 206 as normal. In this way, the distribution type 206 is still classified on the basis of the initial samples 202A of all the client-specific subsets 110, since the distribution type 206 is selected from the distribution types 206′ classified based on the initial samples 202A of respective client-specific subsets 110.

The server device 104 transmits (512) the selected distribution type 206 to the client devices 102, which each responsively receives (514) the selected distribution type 206. Each client device 102 calculates (516) the distribution parameters 208′ of the distribution 204 of the data set 108, where which parameters 208′ are calculated depends on the selected distribution type 206 of the distribution 204. Each client device 102 separately calculates the distribution parameters 208′ from the initial samples 202A of its respective client-specific subset 110. Therefore, the distribution parameters 208′ differ from the distribution parameters 208 of the distribution 204 of the data set 104 in that the parameters 208′ are calculated by each client device 102 just from the initial samples 202A of its respective client-specific subset 110, whereas the parameters 208 are effectively calculated from the initial samples 202A of all the subsets 110.

The client devices 102 each transmit (518) the calculated distribution parameters 208′ to the server device 104, which receives (520) the distribution parameters 208′ from all the client devices 102. The server device 104 in turn calculates (522) selected distribution parameters 208 from the calculated distribution parameters 208′ received the client devices 102. For instance, the server device 104 may average respective types of the distribution parameters 208′ to calculate the selected distribution parameters 208. As an example, the server device 104 may average the mean value of the distribution 204 calculated by received from each client device 102 to calculate the selected mean value, and may similarly average the mean standard deviation calculated by and received from each client device 102 to calculate the selected standard deviation. In this way, the distribution parameters 208 are still calculated on the basis of the initial samples 202A of all the client-specific subsets 110, since the distribution parameters 208 are calculated from the distribution parameters 208′ calculated from the initial samples 202A of respective client-specific subsets 110.

The sever device 104 transmits (524) the selected distribution parameters 208 to the client devices 102, which each responsively receive (526) the distribution parameters 208. The client devices 102 in turn each adjust (528) the data anonymization protocol 214 governing central collection of the client-specific subsets 110 of the data set 108 at the server device 104 based on the distribution type 206 and the distribution parameters 208 that have been received, as has been described. Each client device 102 collects (530) the additional samples 202B of its respective client-specific subset 110 of the data set 108, and reports (532) the samples 202B to the server device 104 in accordance with the adjusted data anonymization protocol 214, as has also been described. The server device 104 therefore centrally collects (534) the additional samples 202B from the client devices 102 as have been anonymized via the data anonymization protocol 214 that was adjusted according to the distribution 204 of the data set 108.

FIGS. 5A and 5B thus differ from FIG. 4 in at least the following ways. First, unlike in FIG. 4, the initial samples 202A do not have to be transmitted in non-anonymized form from the client devices 102 to the server device 104 in FIGS. 5A and 5B. This is because, second, unlike in FIG. 4, the client devices 102 and not the server device 104 apply the trained machine learning model 410 in FIGS. 5A and 5B. Note that this means that once the machine learning model 410 has been trained, the model 410 has to be provided in FIGS. 5A and 5B to each client device 102 in order for its usage to predict the distribution type 206′ of the data set 108, whereas in FIG. 4 the model 410 just has to be provided to the server device 104 and not to any client device 102.

FIG. 5C shows another example method 550 for adjusting central data set collection in which distribution type 206 is locally predicted at each client device 102. Unlike the method 500 of FIGS. 5A and 5B, where the distribution type 206 is initially predicted at each client device 102 but is ultimately selected by the server device 104, the server device 104 does not select the distribution type 206. This means that each client device 102 can use a different distribution type 206 to adjust the data anonymization protocol 214 for reporting collected samples 202 to the server device 104 in the method 550. By comparison, in the method 500, each client device 102 uses the same distribution type 206 to adjust the data anonymization protocol 214 for reporting, as selected by the server device 104.

The left part of the method 550 is again performed by the client devices 102, and the right party by the server device 104. The method 550, like the methods 400 and 500, may be implemented as program code stored on a non-transitory computer-readable data storage medium and executed by a processor of a respective device. Note that whereas in FIGS. 5A and 5B the left part of the method 500 is depicted as to all the client devices 102, in FIG. 5C the left part of the method 550 is depicted as to one such client device 102. The method 550 is therefore described in relation to one client device 102, but each client device 102 in actuality performs the method 550 in FIG. 5C.

A client device 102 locally collects (502) initial samples 202A of its respective client-specific subset 110 of the data set 108, as before. The client device 102 applies (504) the machine learning model 410 to its initial samples to classify the distribution type 206 of the data set 108. Unlike the method 500 of FIGS. 5A and 5B, where the client device 102 classified an initial distribution type 206′ from which the final distribution type 206 on which basis the data anonymization protocol 214 is adjusted is selected by the server device 104, in the method 550, the client device 102 classifies the actual distribution type 206 on which basis the client device 102 then adjusts the protocol 214. As noted, this means that each client device 102 can adjust the data anonymization protocol 214 differently, since the client devices 102 may determine different distribution types 206.

The client device 102 also calculates (516) the distribution parameters 208 of the distribution 204 of its respective client-specific subset 110 of the data set 108. Unlike the method 500 of FIGS. 5A and 5B, where the client device 102 calculated initial distribution parameters 208′ from which the final distribution parameters 208 on which basis the data anonymization protocol 214 is adjusted is determined by the server device 104, in the method 550, the client device 104 calculates the actual distribution parameters 208 on which basis the client device 102 then adjusts the protocol 214. This similarly means that each client device 102 can adjust the data anonymization protocol 214 differently, since the client devices 102 are likely to determine different distribution parameters 208.

The client device 102 thus adjusts (528) the data anonymization protocol 214 governing central collection of its respective client-specific subset 110 of the data set 108 at the server device 104 based on the distribution type 206 and the distribution parameters 208 as determined by the client device 102 itself, as opposed to as determined by the server device 104 in the method 500 of FIGS. 5A and 5B. The client device 102 therefore collects (530) the additional samples 202B of its respective client-specific subset 110 of the data set 108, and reports (532) them to the server device 104 in accordance with the adjusted data anonymization protocol 214. The server device 104 in this way centrally collects (534) the additional samples 202B from the client device 102 as has been anonymized via the data anonymization protocol 214 that was adjusted according to the distribution 204 of the client-specific subset 110 of the data set 108 for the client device 102.

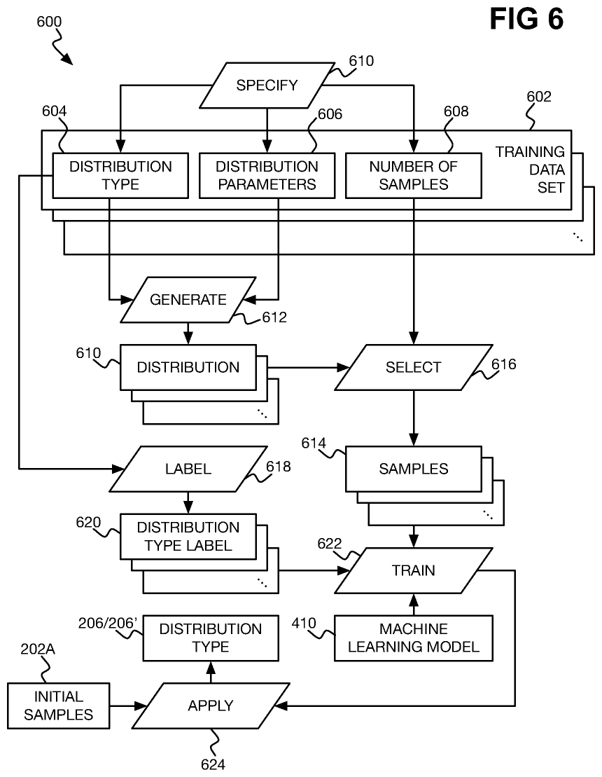

FIG. 6 shows an example process 600 for training the machine learning model 410 to classify, predict, or estimate the distribution type 206/206′ of the data set 108 from a minimum number of initial samples 202A, including as few as five or ten such samples 202A. The machine learning model 410 may in one implementation be a random forest classifier having 200 decision trees. Other examples of the machine learning model 410 can include an AdaBoost model and a support vector machine (SVM) model. The process 600 includes specifying, for each of a number of training data sets 602, a distribution type 604 of the data set 602, distribution parameters 606 of the data set 602, and a specified number 608 of samples that the data set 602 is to have.

For example, there may be 50,000 training data sets 602. For each of a number of specified distribution types 604, there may be different specified combinations of distribution parameters 606. For example, there may be normal distributions that have means and standard deviations of 0 and 1, 2 and 5, and −5 and 1, respectively. The distribution type 604 of each training data set 602 may be randomly selected from the specified distribution types 604, and then the distribution parameters 606 selected from the specified combinations of distribution parameters 606 for the selected distribution type 604. The specified number 608 of samples may be identical for each training data set 602, or may be randomly selected from a specified range, such as between five and ten such samples.

The process 600 includes then generating (612) a distribution 610 for each training data set 602 having the specified distribution type 604 and the specified distribution parameters 606 of that training data set 602. From the distribution 610 for each training data set 602, the process 600 includes randomly selecting (616) the specified number 608 of samples 614 from that distribution 610. That is, randomly selected samples 614 for each training data set 602 are generated, where each randomly selected sample 614 is within the generated distribution 610 for that training data set 602. The number of such randomly selected samples 614 for each training data set 602 is the number 608 of samples specified for that training data set 602.

In another implementation, the training data sets 602 may include historical data previously collected from a number of client devices. In this case, the distribution 610 of the historical data of each training data set 602 is identified, where the distribution 610 of each set 602 is thus of a particular distribution type 604. Randomly selected samples 614 are then chosen from the historical data of each training data set 602.

The process 600 includes also labeling (618) the distribution type 604 of each training data set 602 to generate distribution type labels 620 respectively corresponding to the training data sets 602. Training data sets 602 having the same distribution type 604 but that have different distribution parameters 606 are nevertheless assigned the same labels. For example, two training data sets 602 that have the same normal distribution type 604 may have different distribution parameters 606. The first set 602 may have a mean of X1 and a standard deviation of Y1 as its distribution parameters 606, and the second set 602 may have a mean of X2 and a standard deviation of Y2 as its distribution parameters 606. Both training data sets 602 are assigned the same label, however, since they both have the same normal distribution type 604.

There may be a group of specified labels, including specific distribution labels that each correspond to a specific distribution type, and one non-specific distribution label that corresponds to distribution types other than the specific distribution type of any specific distribution label. For example, there may be specific distribution labels for more common distribution types 604, including normal, exponential, lognormal, uniform, Beta, binominal, negative binomial, and/or Poisson, etc. There may also be a non-specific distribution label that generally corresponds to all other, less common distribution types 604, such as Zeta, Gamma, and/or arcsine, etc. Therefore, each training data set 602 has a distribution type label 620 that is either a specific distribution label or the non-specific distribution label, depending on the actual distribution type 604 of the training data set 602 in question.

The process 600 includes then training (622) the machine learning model 410 from the randomly selected samples 614 of the training data sets 602 and the distribution type labels 620 assigned to the training data sets 602. Once trained, the machine learning model 410 can be used to classify the distribution type of an input data set from a minimum number of samples, as has been described. For instance, the trained machine learning model 410 can be applied (624) to initial samples 202A of one or multiple client-specific subsets 110 of the data set 108 to classify the distribution type 206 or 206′ of the data set 108 depending on whether the initial samples 202A are from all the subsets 110 per FIG. 4 or from one subset 110 per FIGS. 5A and 5B. In FIG. 6, then, the machine learning model 410 is trained from the actual numeric values of the samples 614, and once trained is applied to the actual numeric values of the initial samples 202A.

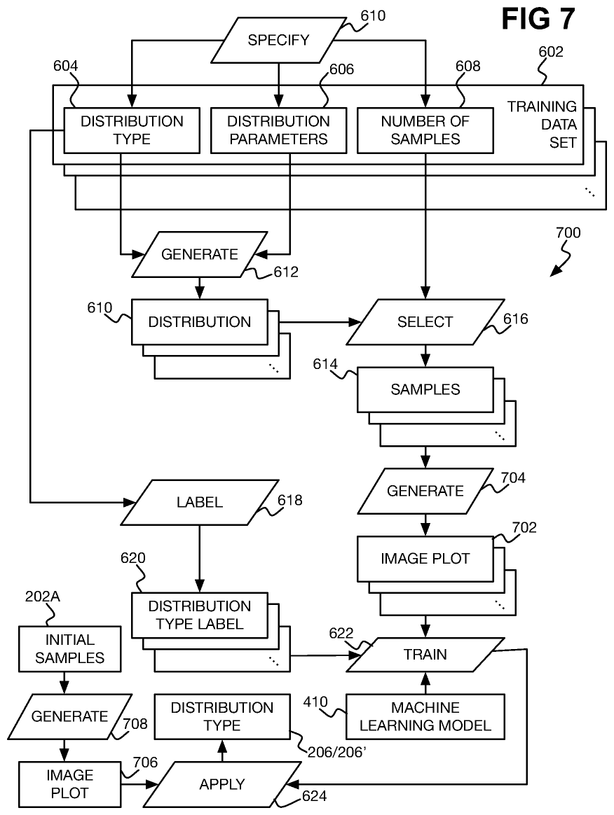

FIG. 7 shows another example for training the machine learning model 410 to classify, predict, or estimate the distribution type 206/206′ of the data set 108 from a minimum number of initial samples 202A. The machine learning model 410 may be in one implementation be an image-classification neural network, such as a deep neural network. Like the process 600 of FIG. 6, the process 700 includes specifying, for each training data set 602, a distribution type 604, distribution parameters 606, and a specified number 608 of samples that the data set 602 is to have. The process 700 again includes generating a distribution 610 for each training data set 602 having the specified distribution type 604 and the specified distribution parameters 606 of that data set 602, and randomly selecting samples 614 from the generated distribution 610, where the number of samples 614 is equal to the number 608 of samples specified for the training data set 602 in question.

However, in FIG. 7, the process 700 includes generating (704) image plots 702 of the randomly selected samples 614 of the training data sets 602. The image plot 702 for each training data set 602 is a graphical (e.g., pixel-based) image of a plot of the randomly selected samples 614, such as in JPEG, PNG, or another image file format. The x-axis of each plot 702 may be normalized to a set time period, with the samples 614 of a plot 702 uniformly occurring during the set time period. For example, for a set time period of one second, the image plot 702 for a training data set 602 that has five samples 614 may have the samples 614 occurring at times 0.2, 0.4, 0.6, 0.8, and 1.0 seconds, respectively. By comparison, the image plot 702 for a training data set 602 that has ten samples 614 may have the samples occurring at times 0.1, 0.2, 0.3, 0.4, . . . , 0.9, 1.0 seconds. The y-axis of each plot 702 may similarly be normalized to a set value range, such as between zero and one, with the samples 614 of a plot 702 having their values normalized to this set range.

The process 700 again includes labeling (618) the distribution type 604 of each training data set 602 to generate distribution type labels 620 respectively corresponding to the training data sets 602. The process 700, similar to the process 600 of FIG. 6, includes training (622) the machine learning model from the randomly selected samples 614 of the training data sets 602 and the distribution type labels 620 assigned to the training data sets 602. However, in the process 700, the machine learning model 410 is specifically trained from the image plots 702 of the random samples 614, instead of from the actual numeric values of the samples 614 as in the process 600.

Once trained, the machine learning model 410 can be used to classify the distribution type of an input data set from a minimum number of samples, similar to as has been described, but on the basis of an image plot of the samples of the input data set as opposed to on the basis of the actual numeric values of the samples. For instance, an image plot 706 may be generated (708) from the initial samples 202A of one or multiple client-specific subsets 110 of the data set 108, in the same manner in which the image plots 702 of the randomly selected samples 614 of the training data sets 602 were generated. The trained machine learning model 410 can then be applied (624) to the image plot 706 of the initial samples 202A to classify the distribution type 206 or 206′ of the data set 108.

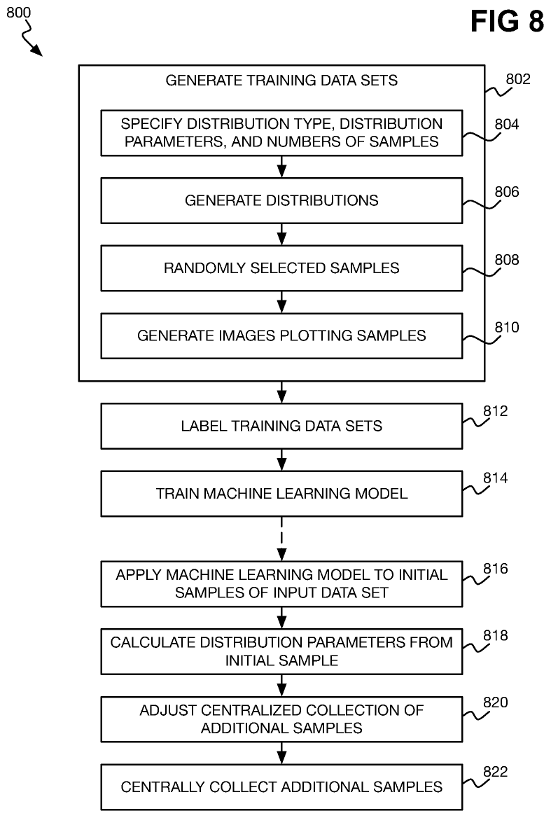

FIG. 8 shows an example method 800. The method 800 may be performed by a processor of a computing device, such as the server device 104. The method 800 may be implemented as program code stored on a memory or other non-transitory computer-readable data storage medium and executed by the computing device. The method 800 includes generating training data sets 602 (802) that each have a distribution type 604, distribution parameters 606, and a specified number 608 of randomly selected samples.

For instances the method can include specifying the distribution type 604, the distribution parameters 606, and the number 608 of randomly selected samples of the training data sets 602 (804). The method 800 can include generating a distribution 610 of each training data set 602 having the distribution type 604 and the distribution parameters 606 of that data set 602 (806), and randomly selecting the specified number 608 of samples 614 from the generated distribution 610 of the data set (808). In one implementation, the method 800 can include, for each training data set 602, generating an image plotting the randomly selected samples 614 of that data set 602 (810).

The method 800 includes labeling the training data sets 602 with labels 620 (812). The label 620 of each training data set 602 corresponds to the distribution type 604 of that data set 602. The method 800 includes training a machine learning model 410 from the training data sets 602 and their labels 618 (814), where the machine learning model 410 classifies a distribution type of an input data set from a minimum number of initial samples of the input data set. The machine learning model 410 may be trained from the actual numeric values of the randomly selected samples 614 of the training data sets 602, or from the generated images plotting these samples 614.

The method 800 can include then applying the trained machine learning model to the initial samples of the input data set—either to their actual numeric values or to an image plotting the values—to predict the distribution type of the input data set (816). The method 800 can include calculating distribution parameters of a distribution of the predicted distribution type from the initial samples of the input data set (818), and adjusting centralized collection of additional samples of the input data set based on the predicted distribution type and the calculated distribution parameters (820). For instance, a data anonymization protocol 214, such as an adaptive differential privacy protocol having variably sized bins, governing the centralized collection of the additional samples may be adjusted. The method 800 can include then centrally collecting the additional samples as so adjusted (822).

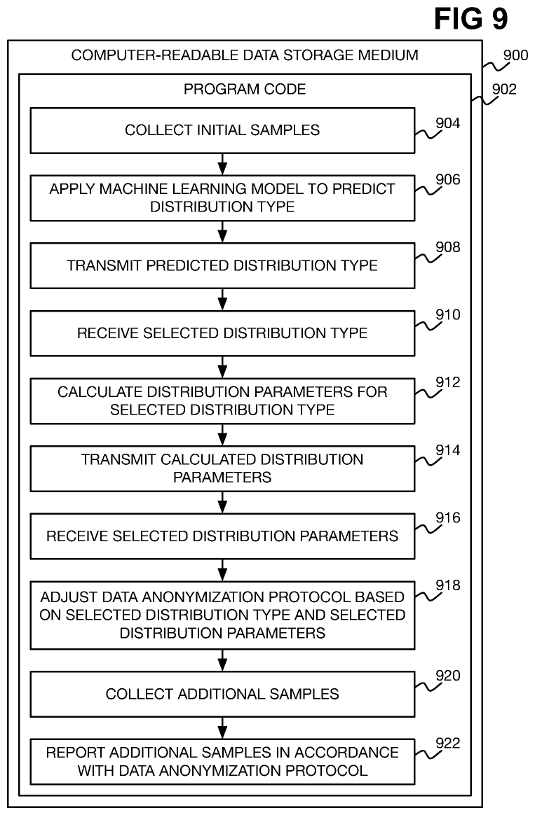

FIG. 9 shows an example non-transitory computer-readable data storage medium 900 storing program code 902 executable by a processor of a client device 102 to performing processing. The processing includes collecting a specified number of initial samples 202A of a client-specific subset 110 of a data set 108 (904), and applying a trained machine learning model 410 to the initial samples 202A to predict a distribution type 206′ of the data set 108 (906). (It is noted that the machine learning model 410 may be trained by the server device 104 or in other cases by the client device 102 itself.) The processing includes transmitting the predicted distribution type 206′ of the data set 108 to a server device 104 that also receives predicted distribution types 206′ of the data set 108 from other client devices 102 based on application of the training machine learning model 410 to initial samples 202A of respective other client-specific subsets 110 of the data set 108 (908).

The processing includes receiving a selected distribution type 206 from the server device 104 that chooses the selected distribution type 206 from the predicted distribution types 206′ received from the client device 102 and the other client devices 102 (910). The processing includes calculating distribution parameters 208′ of a distribution 204 of the selected distribution type 206 from the initial samples 202A of the client-specific subset 110 of the data set 108 (912). The processing includes transmitting the calculated distribution parameters 208′ to the server device 104 that also receives calculated distribution parameters 208′ of the distribution 204 of the selected distribution type 206 from the other client devices 102 as calculated from the initial samples 202A of the respective other client-specific subsets 110 of the data set 108 (914).

The processing includes receiving selected distribution parameters 208 from the server device 104 that determines the selected distribution parameters 208 from the calculated distribution parameters 208′ received from the client device 102 and the other client devices 102 (916). The processing includes adjusting a data anonymization protocol 214 governing centralized data collection by the server device 104 from the client device 102, based on the selected distribution type 206 and the distribution parameters 208 (918). The processing includes collecting additional samples 202B of the client-specific subset 110 of the data set 108 (920), and reporting the additional samples 202B of the client-specific subset 110 of the data set 108 in accordance with the data anonymization protocol 214 as has been adjusted (922). No collected samples 202 are thus transmitted from the client device 102 to the server device 104 without undergoing data anonymization in accordance with the data anonymization protocol 214.

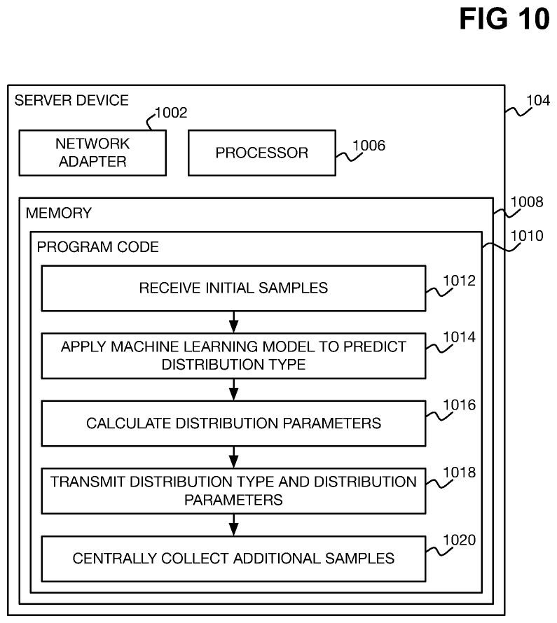

FIG. 10 shows an example server device 104. The server device 104 includes a network adapter 1002 to communicatively connect to client devices 102 over a network 106, a processor 1006, and a memory 1008 storing program code 1010 executable by the processor 1006. The server device 104 can include other components in addition to those depicted. The program code 1010 is executable to receive from each client device 102 a specified number of initial samples 202A of a respective client-specific subset 110 of a data set 108 (1012). The program code 1010 is executable to apply a trained machine learning model 410 to the initial samples 202A received from the client devices 102 to predict a distribution type 206 of the data set 108 (1014).

The program code 1010 is executed to calculate distribution parameters 208 of a distribution 204 of the predicted distribution type 206 from the initial samples 202A received from the client devices 102 (1016). The program code 1010 is executed to transmit to each client device 102 the predicted distribution type 206 and the calculated distribution parameters 208 (1018), in accordance with each client device 102 to adjust a data anonymization protocol 214 governing centralized data collection by the server device 104 from the client device 102. The program code 1010 is executed to centrally collect from the client devices 102 additional samples 202B of the respective client-specific subsets 110 of the data set 108 as reported by the client devices 102 in accordance with the adjusted data anonymization protocol 214 (1020). No additional samples 202B are thus centrally collected by the server device 102 without undergoing data anonymization in accordance with the data anonymization protocol 214 at the client devices 102.

Techniques have been described for classifying the distribution type of a data set from a minimal number of initial samples of the data set. The classified distribution type, along with distribution parameters calculated from the initial samples, can be used to adjust collection of samples of the data set. For example, a data anonymization protocol may be adjusted according to the classified distribution type and the calculated distribution parameters. As such, how the data is collected is adjusted, in a manner that provides for more accurate analyses of the resultantly collected anonymized data.

We claim:

1. A method comprising:
generating, by a processor, a plurality of training data sets, each training data set having a distribution type and a specified number of randomly selected samples;
labeling, by the processor, the training data sets with labels, the label of each training data set corresponding to the distribution type of the training data set; and
training, by the processor, a machine learning model from the training data sets and the labels, the machine learning model classifying a distribution type of an input data set from a minimum number of initial samples of the input data set.

2. The method of claim 1, wherein the minimum number of initial samples of the input data set is the minimum number of initial samples sufficient for the machine learning model to classify the distribution type with a specified accuracy.

3. The method of claim 1, wherein the minimum number of initial samples of the input data set is no more than ten initial samples of the input data set.

4. The method of claim 1, further comprising:
applying, by the processor, the machine learning model to the initial samples of the input data set to predict the distribution type of the input data set; and
adjusting, by the processor, centralized collection of additional samples of the input data set based on the predicted distribution type.

5. The method of claim 4, further comprising:
calculating distribution parameters of a distribution of the predicted distribution type from the initial samples of the input data set,
wherein the centralized collection of the additional samples of the data set is further adjusted based on the calculated distribution parameters.

6. The method of claim 4, wherein adjusting the centralized collection of the additional samples of the input data set comprises:
adjusting a data anonymization protocol governing the centralized collection of the additional samples of the input data, based on the predicted distribution type,
wherein the data anonymization protocol comprises an adaptive differential privacy protocol having variably sized bins in accordance with the predicted distribution type.

7. The method of claim 1, wherein generating the training data sets comprises, for each training data set:
generating an image plotting the randomly selected samples of the training data set,
wherein the machine learning model is trained from the image plotting the randomly selected samples of each training data set, and the model classifies the distribution type of an input data set from an image of the minimum number of initial samples of the input data set,
and wherein the machine learning model comprises an image-classification neural network.

8. The method of claim 1, wherein labeling the training data set with the labels comprises, for each training data set:
labeling the training data set with the label corresponding to the distribution type of the training data set, from a group of specified labels including specific distribution labels that each correspond to a specific distribution type and a non-specific distribution label that corresponds to distribution types other than the specific distribution type of any specific distribution label.

9. A non-transitory computer-readable data storage medium storing program code executable by a processor of a client device to perform processing comprising:
collecting a specified number of initial samples of a client-specific subset of a data set;
applying a trained machine learning model to the initial samples to predict a distribution type of the data set; and
adjusting a data anonymization protocol governing centralized data collection by a server device from the client device, based on the selected distribution type.

10. The non-transitory computer-readable data storage medium of claim 9, wherein the processing further comprises:
transmitting the predicted distribution type of the data set to the server device that also receives predicted distribution types of the data set from other client devices based on application of the training machine learning model to initial samples of respective other client-specific subsets of the data set;
receiving a selected distribution type from the server device that chooses the selected distribution type from the predicted distribution types received from the client device and the other client devices,
and wherein adjusting the data anonymization protocol based on the selected distribution type comprises adjusting the data anonymization protocol based on the selected distribution type.

11. The non-transitory computer-readable data storage medium of claim 10, wherein the processing further comprises:
calculating distribution parameters of a distribution of the selected distribution type from the initial samples of the client-specific subset of the data set;
transmitting the calculated distribution parameters to the server device that also receives calculated distribution parameters of the distribution of the selected distribution type from the other client devices as calculated from the initial samples of the respective other client-specific subsets of the data set; and
receiving selected distribution parameters from the server device that determines the selected distribution parameters from the calculated distribution parameters received from the client device and the other client devices,
wherein the data anonymization protocol is further adjusted based on the selected distribution parameters.

12. The non-transitory computer-readable data storage medium of claim 9, wherein the processing further comprises:
collecting additional samples of the client-specific subset of the data set; and
reporting the additional samples of the client-specific subset of the data set in accordance with the data anonymization protocol as has been adjusted,
wherein no collected samples of the client-specific subset of the data set are transmitted from the client device to the server device without undergoing data anonymization in accordance with the data anonymization protocol.

13. A server device comprising:
a network adapter to communicatively connect to a plurality of client devices over a network;
a processor; and
a memory storing program code executable by the processor to:
receive from each client device a specified number of initial samples of a respective client-specific subset of a data set;
apply a trained machine learning model to the initial samples received from the client devices to predict a distribution type of the data set; and
transmit to each client device the predicted distribution type, each client device adjusting a data anonymization protocol governing centralized data collection by the server device from the client device, based on the predicted distribution type.

14. The server device of claim 13, wherein the program code is executable by the processor to further:
calculate distribution parameters of a distribution of the predicted distribution type from the initial samples received from the client devices; and
transmit to each client device the calculated distribution parameters, each client device adjust the data anonymization protocol based further on the calculated distribution parameters.

15. The server device of claim 13, wherein the program code is executable by the processor to further:
centrally collect from the client devices additional samples of the respective client-specific subsets of the data sets as reported by the client devices in accordance with the data anonymization protocol as has been adjusted based on the predicted distribution type,
wherein no additional samples of the respective client-specific subsets of the data set are centrally collected by the server device from the client devices without undergoing data anonymization in accordance with the data anonymization protocol at the client devices.
